(19) United States
(12) Patent Application Publication
(10) Pub. No.: US 2008/0080850 A1
(43) Pub. Date: Apr. 3, 2008

(54) FLASH SHUTTER MECHANISM AND METHOD OF OPERATING SAME

(75) Inventors: Habib Amirzadeh, Weston, FL (US); Julio C. Castaneda, Coral Springs, FL (US)

Correspondence Address: MOTOROLA, INC, 1303 EAST ALGONQUIN ROAD, IL01/3RD, SCHAUMBURG, IL, 60196, US

(73) Assignee: Motorola, Inc., Schaumburg, IL (US)

(21) Appl. No.: 11/537,249

(22) Filed: Sep. 29, 2006

(51) Int. Cl. G03B 15/03

(52) U.S. Cl. 396/155

(57) ABSTRACT

The invention concerns a flash shutter mechanism (105) and a method (200) of operating same. The mechanism can include a flash (114) that may illuminate when an image is captured and a lens (116) that can cover the flash, including when the flash is illuminated. The lens can have a substantially transparent state and a substantially opaque state. In particular, the lens can be in the substantially transparent state when a camera mode is activated and can be in the substantially opaque state when the camera mode is deactivated. In one arrangement, the shutter mechanism can be positioned in a camera phone (100), and when the lens is in the substantially opaque state, the lens can have a color that may substantially match a portion of a housing (118) of the camera phone. The lens may also cover an image capture device (112).

### BACKGROUND OF THE INVENTION

1. Field of the Invention

The present invention concerns camera flashes and more particularly, controlling a shutter mechanism for a camera flash.

2. Description of the Related Art

Cameras have been widely implemented in cell phones, and their use by the general public has proliferated. Some higher end models of cell phones include flashes to help overcome poor lighting conditions when a user snaps a picture with his/her camera phone. Such a flash is typically a light emitting diode (LED) flash that is designed to temporarily illuminate when the camera is actuated by the user. To enhance performance, the flash LED is generally designed to have a yellow color.

Unfortunately, the yellow color of the flash LED clashes aesthetically with the color schemes of many different handsets. The overall appearance of today's handsets have been given priority, given that manufacturers have attempted to entice customers into buying cell phones based on how the phones look. To overcome the yellow color of the flash LED, some manufacturers have covered the flash LED with a white transreflective layer that covers the flash LED. While this structure does hide the yellow color of the flash LED, it reduces the performance of the flash LED because it blocks a significant amount if light from the flash.

### SUMMARY OF THE INVENTION

The present invention concerns a flash shutter mechanism. The mechanism can include a flash that can illuminate when an image is captured and a lens that can cover the flash, including when the flash is illuminated. The lens can have a substantially transparent state and a substantially opaque state. For example, the lens can be in the substantially transparent state when a camera mode is activated and can be in the substantially opaque state when the camera mode is deactivated. When a voltage is applied to the lens, the lens may enter the substantially transparent state or the substantially opaque state.

In one arrangement, the shutter mechanism can be positioned in a camera phone. When the lens is in the substantially opaque state, the lens can have a color that can substantially match a portion of a housing of the camera phone. The camera phone may include an activator that can activate and deactivate the camera mode. As an example, the activator can be a button on a keypad of the camera phone. As another example, the lens can be a cholesteric lens, a polymer dispersed liquid crystal lens or a portion of a liquid crystal display module.

The present invention also concerns another flash shutter mechanism. Here, the mechanism can include an image capture device that can capture images and a lens that can cover a portion of the image capture device, including when the image capture device is activated to capture an image. Similar to the lens described above, the lens in this example can have a substantially transparent state and a substantially opaque state in which the lens can be in the substantially transparent state when a camera mode is activated and can be in the substantially opaque state when the camera mode is deactivated. The lens in this example can also cover the flash, as explained above.

The present invention also concerns a camera phone. The camera phone can include an image capture device, a flash that can illuminate when the image capture device is activated and a multi-state lens that can permanently cover the flash. The lens can have a substantially transparent state and a substantially opaque state. Additionally, the multi-state lens can be in the substantially transparent state when the image capture device is activated and can be in the substantially opaque state when the image capture device is deactivated. The camera phone may also include a housing in which a color of the multi-state lens substantially matches a color of the housing when the multi-state lens is in the substantially opaque state. Moreover, the camera phone can include a keypad having one or more buttons that can cause the image capture device to be activated.

The present invention also concerns a method of selectively covering a flash. The method can include the steps of entering a camera activation mode, moving a lens that permanently covers the flash to a substantially transparent state, entering a camera deactivation mode and moving the lens from the substantially transparent state to a substantially opaque state.

### BRIEF DESCRIPTION OF THE DRAWINGS

The features of the present invention, which are believed to be novel, are set forth with particularity in the appended claims. The invention, together with further objects and advantages thereof, may best be understood by reference to the following description, taken in conjunction with the accompanying drawings, in the several figures of which like reference numerals identify like elements, and in which:

FIG. 1 illustrates a camera phone and flash shutter mechanism in accordance with an embodiment of the inventive arrangements; and

FIG. 2 illustrates a method for selectively covering a flash in accordance with an embodiment of the inventive arrangements.

### DETAILED DESCRIPTION OF THE INVENTION

While the specification concludes with claims defining the features of the invention that are regarded as novel, it is believed that the invention will be better understood from a consideration of the following description in conjunction with the drawings, in which like reference numerals are carried forward.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled” as used herein, are defined as connected, although not necessarily directly, and not necessarily mechanically. The term “processor” can include any component or group of components, including any relevant hardware and/or software, that can carry out the functions described in relation to the inventive arrangements herein. “Portion” can be defined as a part of something or even the entire thing.

The term “flash” can be defined as one or more illumination sources that provide light for the operation of a device that captures images. A “lens” can be defined as any structure that selectively permits the transfer of light through that structure. The term “cover” or “covers” can be defined as to be placed entirely or partially over something. Further, the term “substantially transparent” can mean permitting the passage of light, at least to a level to where the light can enhance current lighting conditions for a subject to be photographed. Conversely, the term “substantially opaque” can mean substantially blocking the passage of light, at least to a level to where a particular component is hidden from view.

Also, the term “activate,” “activating,” “activated” or “activation” can be defined as to initiate or to start, while the term “deactivate,” “deactivating,” “deactivated” or “deactivation” can mean to disable, shut off or suspend. The word “permanently” can mean the property of being fixed, such as an object that is not designed to be moved, opened or removed. A “camera mode” can be defined as a state of operation in which an image capture device is activated to be able to capture images or when a flash enters a pre-illumination stage or when the flash is activated without the image capture device being activated. A “camera phone” can be defined as a mobile communications unit that has the ability to capture images.

The invention concerns a flash shutter mechanism and a method for operating same. The flash shutter mechanism can include a flash that illuminates when an image is captured and a lens that can cover the flash, including when the flash is illuminated. The lens may also cover an image capture device, including when the device captures an image. In one arrangement, the lens can have a substantially transparent state and a substantially opaque state. As an example, the lens can be in the substantially transparent state when a camera mode is activated and can be in the substantially opaque state when the camera mode is deactivated.

In another arrangement, the shutter mechanism can be positioned in a camera phone. When the lens is in the substantially opaque state, the lens can have a color that can substantially match a portion of a housing of the camera phone. This way, the lens does not interfere with the operation of the flash when pictures are taken, yet the flash (and/or an image capture device) is covered when the camera is not in use to prevent the flash from spoiling the appearance of the phone in which it is implemented.

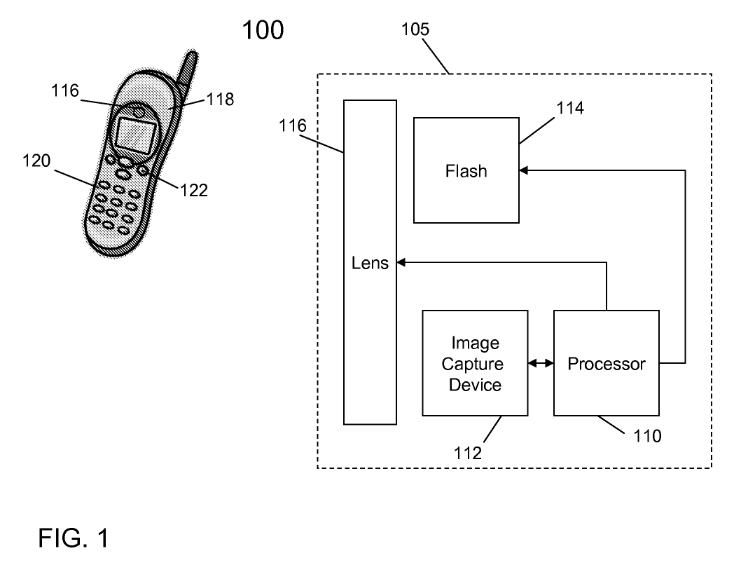

Referring to FIG. 1, an example of a camera phone 100 and a corresponding block diagram are shown. In one arrangement, the camera phone 100 can include a flash shutter mechanism 105 having a processor 110, an image capture device 112, a flash 114 and a lens 116, each of which may be under the control of the processor 110. The camera phone 100 may also include a housing 118 and a keypad 120, which can include one or more activators 122, such as buttons, touch screen displays or scroll wheels. The image capture device 112 can be any suitable component or components that are able to capture images for viewing by a user, such as a camera that takes still pictures or a video camera. In addition, the flash 114 can illuminate when the image capture device 112 is activated, i.e., when an image is captured. As an example, the flash 114 can be an LED that can supplement lighting conditions to enhance image capture. Those of skill in the art will appreciate, however, that the flash 114 is not limited to this example, and other suitable illumination sources may be used.

In one arrangement, the lens 116 can cover the flash 114, including when the flash 114 is illuminated. In other words, the lens 116 can permanently cover the flash 114. As an example, the lens 116 can be a cholesteric lens or a polymer dispersed liquid crystal (PDLC) lens. As another example, the lens 116 can be a portion of a liquid crystal display module. As is known in the art, a cholesteric lens and a PDLC lens can move between substantially transparent and opaque states. Moreover, it is known in the art that an LCD can move between states that permit light to pass through the display or that block light from emitting from the display. As will be explained below, to cause the lens 116 to move between transparent and opaque states, the processor 110 can apply a predetermined voltage level to the lens 116.

In another arrangement, the lens 116 may also cover a portion of the image capture device 112. For example, the lens 116 may cover that portion of the image capture device 112 that is exposed through or outside the housing 118, such as an opening for the device 112. Similar to the description above, the lens 116 may cover the device 112 when the device 112 is or is not in the process of capturing images. If so desired, the lens 116 can be comprised of two separate portions in which the transparency of the two portions are independent of one another. For example, the use of the flash 114 may not be necessary, and it can remain hidden from view by the lens 116 being in an opaque state. Conversely, the portion of the lens 116 covering the image capture device 112 can be made transparent to permit the operation of the device 112 without the flash 114.

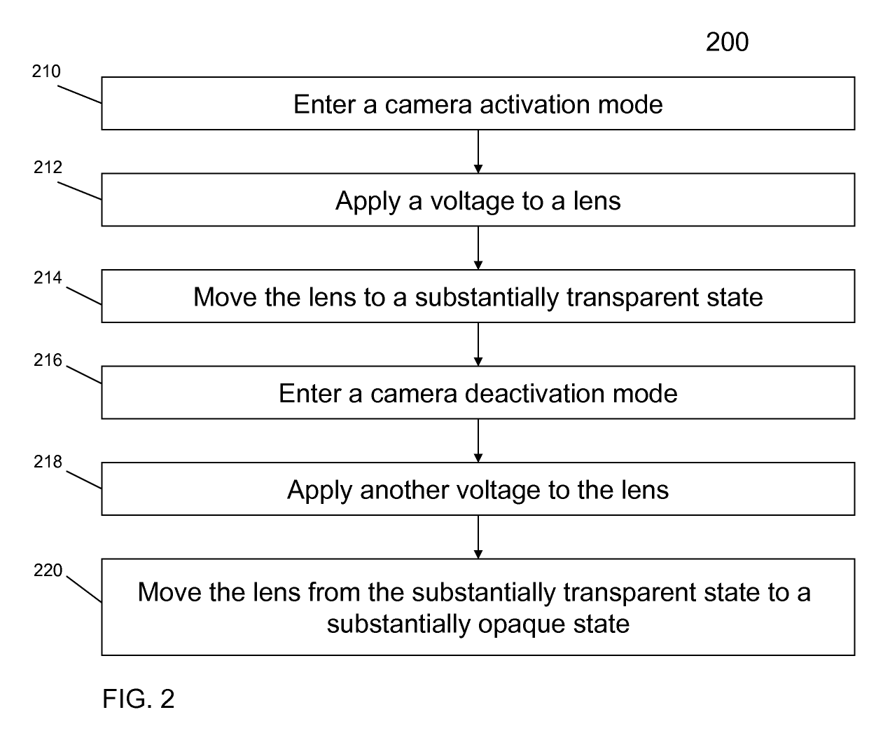

Referring to FIG. 2, a method 200 for operating a flash shutter mechanism is shown. When describing the method 200, reference will be primarily made to FIG. 1, although it is understood that the method 200 can be practiced in any other suitable system or device. The steps of the method 200 are not limited to the particular order in which they are presented in FIG. 2. The inventive method can also have a greater number of steps or a fewer number of steps than those shown in FIG. 2.

At step 210, a camera activation mode can be entered, and at step 212, a voltage can be applied to a lens. The lens can then be moved to a substantially transparent state, as shown at step 214. For example, referring to FIG. 1, the camera phone 100 can enter a camera activation mode. In particular, a user may operate one or more activators 122, such as pressing a programmable key on the keypad 120, to cause the image capture device 112 to enter a state in which it is ready to capture images. At this point, a voltage can be applied to the lens 116, which can cause the lens 116 to become substantially transparent.

As an example, if the lens 116 is a cholesteric lens or a PDLC lens, the lens 116 can transition to a state in which the lens 116 can allow light to pass through it. As another example, the lens 116 may be a portion of an LCD module, which is separate from the main display portion of the LCD module. In this example, the portion of the LCD module covering the flash 114 and/or the image capture device 112 can have two states. One state can be LCD essentially preventing light from passing through the LCD, while the other can be the LCD allowing light to pass through. In this case, the uniformity of the light from the flash 114 is not significant, and as such, a diffusion panel may not be required for the portion of the LCD module covering the flash 114. In either arrangement, because the lens 116 is in a substantially transparent state, light from the flash 114 can easily pass through the lens 116, thereby enhancing lighting conditions when an image is captured. The substantially transparent state of the lens 116 can also allow for proper operation of the image capture device 112.

It is understood, however, that the invention is not limited to these examples. Specifically, the lens 116 may be constructed of other suitable bi-stable clear-reflective materials or other suitable structure that selectively permits the transfer of light depending on whether the camera mode is activated.

Referring back to FIG. 2, at step 216, a camera deactivation mode can be entered, and at step 218, another voltage can be applied to the lens. In addition, at step 220, the lens can be moved from the substantially transparent state to a substantially opaque state. For example, referring again to FIG. 1, a user can operate an activator 122, again, such as a button on the keypad 120, to deactivate the camera mode, or the user may simply close the camera phone 100, if the phone 100 is a clamshell model. This step can return the image capture device 112 to a resting or deactivated state, such that it is not ready to capture images. A voltage can then be applied to the lens 116.

As an example, if the lens 116 is a cholesteric lens or a PDLC lens, the lens 116 can transition from the substantially transparent state to a substantially opaque state. In the substantially opaque state, the lens 116 can prevent light from passing through the lens 116, which can hide the flash 114 and/or the image capture device 112 from view. If the lens 116 is a portion of an LCD module, the LCD covering the lens 116 can be set to a substantially opaque state. It is understood that an LCD may be controlled by selectively applying a voltage and then removing the voltage, as opposed to applying a second voltage. In other words, the LCD may not necessarily be a bi-stable display. In this case, the step of applying two voltages at different times may not be necessary in this scenario, as the first voltage may only need to be removed from the lens 116.

In one arrangement, the color of the lens 116 in the substantially opaque state can substantially match the color of a portion of the housing 118. In particular, if the lens 116 is a cholesteric lens or a PDLC lens, the liquid crystal material can be of a color that substantially matches the color of the housing 118 when the lens 116 is in the substantially opaque state (e.g., the planar state). For example, this material may have a monochromatic grey color when the lens 116 is in the substantially opaque state, although other color arrangements are possible, as appreciated by one of skill in the art. If the choices of color for the lens 116 are limited, the portion of the housing 118 surrounding the lens 116 may be geared towards matching this color, as the colors available for the housing 118 are numerous.

Alternatively, if the lens 116 is a portion of an LCD module, then the display can be set to a color that substantially matches the housing 118. Thus, when the lens 116 is in the substantially opaque state, the flash 114 and/or the image capture device 112 can be hidden from view without detracting from the overall appearance of the camera phone 100. This process of shifting between transparent and opaque states can occur repeatedly, depending on when the camera mode is activated and deactivated.

As is known in the art, the flash 114 may be manually activated by a user in certain situations. For example, if a user is going to take a picture in a dark environment, the user may cause the flash 114 to enter a pre-illumination stage to help locate in a viewfinder an object to be photographed. At this point, the flash 114 may give off only a fraction of its normal light output when a picture is taken. In accordance with the above description, the lens 116 can enter the substantially transparent state when the flash 114 is in this pre-illumination stage. While this stage may typically not be entered until after the image capture device 112 is ready to capture an image, it is important to note that the invention is not limited as such. There may be circumstances where the flash 114 is in a pre-illumination stage without the device 112 set to take a picture, such as if the user wanted to use the flash 114 to help locate a missing object in a low-light environment. Of course, in this scenario, the user may even cause the flash 114 to illuminate at the level used for picture taking to find such an object.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. A flash shutter mechanism, comprising:
a flash that illuminates when an image is captured; and
a lens that covers the flash, including when the flash is illuminated, and that has a substantially transparent state and a substantially opaque state, wherein the lens is in the substantially transparent state when a camera mode is activated and is in the substantially opaque state when the camera mode is deactivated.

2. The mechanism according to claim 1, wherein the shutter mechanism is positioned in a camera phone, and when the lens is in the substantially opaque state, the lens has a color that substantially matches a portion of a housing of the camera phone.

3. The mechanism according to claim 1, wherein the shutter mechanism is positioned in a camera phone that includes an activator that activates and deactivates the camera mode.

4. The mechanism according to claim 3, wherein the activator is a button on a keypad of the camera phone.

5. The mechanism according to claim 1, wherein when a voltage is applied to the lens, the lens enters the substantially transparent state or the substantially opaque state.

6. The mechanism according to claim 1, wherein the lens is a cholesteric lens, a polymer dispersed liquid crystal lens or a portion of a liquid crystal display module.

7. A camera phone, comprising:
an image capture device;
a flash that illuminates when the image capture device is activated; and
a multi-state lens that permanently covers the flash and that has a substantially transparent state and a substantially opaque state, wherein the multi-state lens is in the substantially transparent state when the image capture device is activated and is in the substantially opaque state when the image capture device is deactivated.

8. The camera phone according to claim 7, further comprising a housing, wherein a color of the multi-state lens substantially matches a color of the housing when the multi-state lens is in the substantially opaque state.

9. The camera phone according to claim 7, further comprising a keypad having one or more buttons that cause the image capture device to be activated.

10. A flash shutter mechanism, comprising:
an image capture device that captures images; and
a lens that covers a portion of the image capture device, including when the image capture device is activated to capture an image, and that has a substantially transparent state and a substantially opaque state, wherein the lens is in the substantially transparent state when a camera mode is activated and is in the substantially opaque state when the camera mode is deactivated.

11. The mechanism according to claim 10, further comprising a flash that selectively illuminates when the image capture device captures the image and wherein the lens also covers the flash, including when the flash is illuminated.

12. A method of selectively covering a flash, comprising:
entering a camera activation mode;
moving a lens that permanently covers the flash to a substantially transparent state;
entering a camera deactivation mode; and
moving the lens from the substantially transparent state to a substantially opaque state.

13. The method according to claim 12, wherein when the lens is in the substantially opaque state, a color of the lens substantially matches a color of a housing in which the lens is implemented.

14. The method according to claim 12, further comprising applying a voltage to the lens to cause the lens to move between the substantially transparent state and the substantially opaque state.
